(19) United States
(12) Patent Application Publication
(10) Pub. No.: US 2018/0018143 A1
(43) Pub. Date: Jan. 18, 2018

(54) Audio Device with Music Listening Function and Surroundings Hearing Function

(71) Applicant: EM-TECH. Co., Ltd., Busan (KR)

(72) Inventors: Choong Sheek Hong, Gyeonggi-do (KR); Taek Jin Han, Gyeonggi-do (KR); Dong Sung Kim, Gyeonggi-do (KR); Sang Hyun Lee, Gyeonggi-do (KR)

(21) Appl. No.: 15/646,394

(22) Filed: Jul. 11, 2017

(30) Foreign Application Priority Data
Jul. 12, 2016 (KR) 1020160088021

(51) Int. Cl. G06F 3/16; H04R 1/10; H04R 29/00

(52) U.S. Cl. CPC G06F 3/165; H04R 29/001; H04R 1/1041; H04R 1/1016

(57) ABSTRACT

An audio device with a music listening function and an ambient listening function is provided, which allows selective implementation of the music listening function and the ambient listening function by simplified user operation. The audio device includes: a communication part configured to perform communication with an external electronic communication device; a microphone part configured to pick up ambient sound; a speaker part configured to emit music or ambient sound; and a controller configured to perform the ambient listening function to pick up ambient sound from the microphone part and emit the ambient sound to the speaker, and perform the music listening function to play an audio file from the communication part or a stored audio file and emit the audio file through the speaker.

### PRIORITY CLAIM

The present application claims priority to Korean Patent Application No. 10-2016-0088021 filed on 12 Jul. 2016, the content of said application incorporated herein by reference in its entirety.

### TECHNICAL FIELD

The present invention relates to an audio device, and more particularly, to an audio device with a music listening function and an ambient listening function which allows selective implementation of the music listening function and the ambient listening function by a simplified user operation.

### BACKGROUND

Generally, people with hearing loss refer to those who cannot hear well enough to understand speech in normal everyday situations—that is, hearing-impaired people. Hearing loss can be categorized as mild, moderate, moderate-severe, severe, etc. according to severity.

There are several types of hearing loss: conductive hearing loss, sensorineural hearing loss, and mixed hearing loss. Hearing loss has multiple causes, including damage to the external ear canal, perforation of the eardrum, disruption of the ossicles, otitis externa, otitis media, ageing, congenital problems, genetics, exposure to noise, hyperthermia, medications, etc., which may be classified by the damage to the bone conduction and air conduction.

Hearing-impaired people face difficulties in hearing in everyday situations, and therefore, they need a hearing aid to compensate for hearing loss well enough. The hearing aid is a device that amplifies a speaking person's voice or ambient sound to help a person with hearing loss hear speech clearly and give them a natural experience of hearing.

Generally, a hearing aid includes a transmitter that picks up a speaking person's voice or ambient sound and outputs it as an electrical signal, an amplifier that receives the signal output from the transmitter and rectifies and amplifies it, a receiver that converts the signal amplified by the amplifier into a sound wave and sends it to the ear of a person with hearing loss, and a battery that supplies electric power to the transmitter, receiver, and amplifier. There are many types of hearing aids, including box-type aids, behind-the-ear aids, eyeglass aids, in-the-ear aids, and, more recently, completely-in-the-canal aids, an enhanced version of the in-the-ear type, which are placed deep in the ear canal.

With conventional hearing aids, the wearer can activate an ambient listening function but cannot use a music listening function.

### SUMMARY

An object of the present invention is to provide an audio device with a music listening function and an ambient listening function, which allows selective implementation of the music listening function and the ambient listening function by a simplified user operation, and which performs the ambient listening function in critical situations while performing the music listening function.

According to an aspect of the present invention, there is provided an audio device with a music listening function and an ambient listening function, including: a communication part that performs communication with an external electronic communication device; a microphone part that picks up ambient sound; a speaker part that emits music or ambient sound; and a controller that performs the ambient listening function to pick up ambient sound from the microphone part and emit the ambient sound to the speaker and that performs the music listening function to play an audio file from the communication part or a stored audio file and emit the audio file through the speaker.

In some embodiments, the controller picks up and analyzes ambient sound by controlling the microphone part while performing the music listening function.

In some embodiments, through the analysis of ambient sound, the controller determines whether the analyzed ambient sound contains a warning signal.

In some embodiments, if the analyzed ambient sound contains a warning signal, then the controller stops the music listening function and performs the ambient listening function.

In some embodiments, the controller performs the ambient listening function for a given period of time and resumes the music listening function.

In some embodiments, the audio device includes an input part that receives at least one among a music listening function selection input, an ambient listening function selection input, and an automatic mode standby input and sends the same to the controller.

In some embodiments, upon receiving an automatic mode standby input, the controller determines whether the communication part is communicatively connected to an electronic communication device.

In some embodiments, if the communication part is communicatively connected to an electronic communication device, then the controller receives an audio file from the electronic communication device and automatically performs the music listening function.

The present invention has an advantage of allowing selective implementation of the music listening function and the ambient listening function by a simplified user operation and performing the ambient listening function in critical situations while performing the music listening function.

Those skilled in the art will recognize additional features and advantages upon reading the following detailed description, and upon viewing the accompanying drawings.

### BRIEF DESCRIPTION OF THE DRAWINGS

FIG. 1 is a block diagram of an audio device with a music listening function and an ambient listening function according to the present invention;

FIG. 2 is a perspective view of the audio device of FIG. 1; and

FIG. 3 is a flowchart of the operation of the audio device with the music listening function and the ambient listening function shown in FIG. 1.

### DETAILED DESCRIPTION

Hereinafter, an audio device with a music listening function and an ambient listening function according to an exemplary embodiment of the present invention will be described in detail with reference to the drawings.

FIG. 1 is a block diagram of an audio device with a music listening function and an ambient listening function according to the present invention. The Bluetooth audio device with the music listening function and the ambient listening function according to the present invention includes a power supply part 1 that supplies required power, an input part 3 that receives a power on/off input, an ambient listening mode selection input, a music listening mode selection input, and an automatic mode standby input, first and second microphones 5a and 5b for picking up ambient sound (voice or audio), an indication part 7 that indicates a power on/off state and which mode (ambient listening mode, music listening mode, or automatic mode) is currently being performed, a speaker 9 that emits sound such as voice, music, or ambient sound, a communication part 11 that performs wired and/or wireless communication (e.g., Bluetooth communication, etc.) with an external electronic communication device (e.g., a smartphone, pad, tablet pc, etc.), and a controller 20 that controls the above-mentioned components and performs either the ambient listening function or the music listening function according to a selection/conversion input from the input part 3, and that, upon receiving an automatic mode standby input, performs the music listening function depending on whether or not the Bluetooth audio device is communicatively connected to an electronic communication device. However, it should be apparent to those skilled in the art that the power supply part 1, the input part 3, the first and second microphones 5a and 5b, the indication part 7, the speaker 9, and the communication part 11 are well-known technologies, so detailed descriptions of them will be omitted.

The music listening mode will be described first. The controller 20 receives from the input part 3 a selection input for the music listening mode made by the wearer, reads a saved audio (or music) file (e.g., mp3, mp4, etc.), converts it into an electrical audio signal using a stored playback application, and sends the electrical audio signal to the speaker 9 to produce audio (music) so that the wearer can hear it. Moreover, the controller 20 indicates through the indication part 7 that the music listening mode is currently being performed. Alternatively, the controller 20 may receive an audio file from an external electronic communication device through the communication part 11, convert it into an electrical audio signal using a stored playback application, and send the electrical audio signal to the speaker 9 to produce audio (music).

Next, the ambient listening mode will be described. The controller 20 receives from the input part 3 a selection input for the ambient listening mode made by the wearer, and operates at least one of the first and second microphones 5a and 5b to pick up ambient sound (voice and audio). In this case, the controller 20 indicates through the indication part 7 that the ambient listening mode is currently being performed. The controller 20 amplifies ambient sound with noise removed therefrom or processes it by a preset method, and sends it to the wearer's hearing organ through the speaker 9.

Next, the automatic mode will be described. The controller 20 receives from the input part 3 an automatic mode standby input made by the user, and then checks whether or not the Bluetooth audio device is communicatively connected to an electronic communication device. If the audio device is communicatively connected to an electronic communication device, then the controller 20 receives an audio file from the electronic communication device, converts it into an electrical audio signal using a stored playback application, and sends the electrical audio signal to the speaker 9 to reproduce audio (music). The controller 20 monitors the communicative connection with the electronic communication device for a certain period of time, and if the audio device is not communicatively connected to the electronic communication device for a certain period of time, then the controller 20 discards the automatic mode standby input and returns to the initial state. Here, the initial state is a state in which the wearer (user) may make an input (a music listening mode selection input, ambient listening mode selection input, automatic mode standby input, etc.) through the input part 3 to be sent to the controller 20.

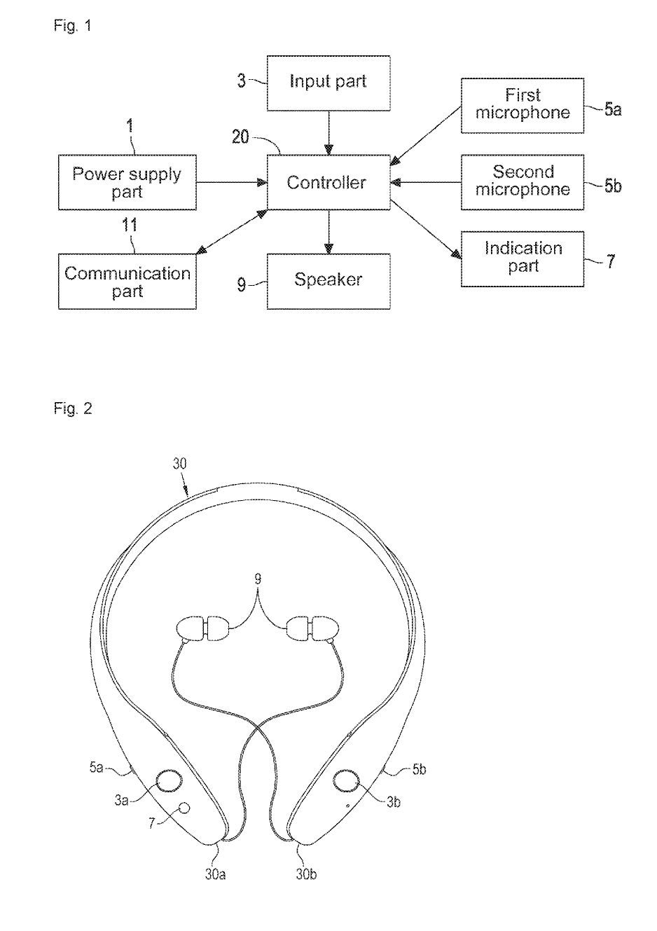

FIG. 2 is a perspective view of the Bluetooth audio device of FIG. 1. The Bluetooth audio device includes a main body portion 30 with an opening between two opposite ends 30a and 30b that is placed around the wearer's neck or on their shoulder.

The input part 3 is provided on the main body portion 30 and selects a power on/off input or a selection input for the ambient listening mode, music listening mode, or automatic mode standby state.

The first and second microphones 5a and 5b face outward to pick up ambient sound (audio and voice).

The indication part 7 indicates that the ambient listening function or music listening function is being performed, and, for example, may consist of one indicator that flashes in different colors (blue and red) or in different patterns.

The speaker 9 consists of a pair of speakers connected respectively to the two opposite ends 30a and 30b of the main body portion 30, which are inserted or placed in the wearer's ears to properly deliver music or voice.

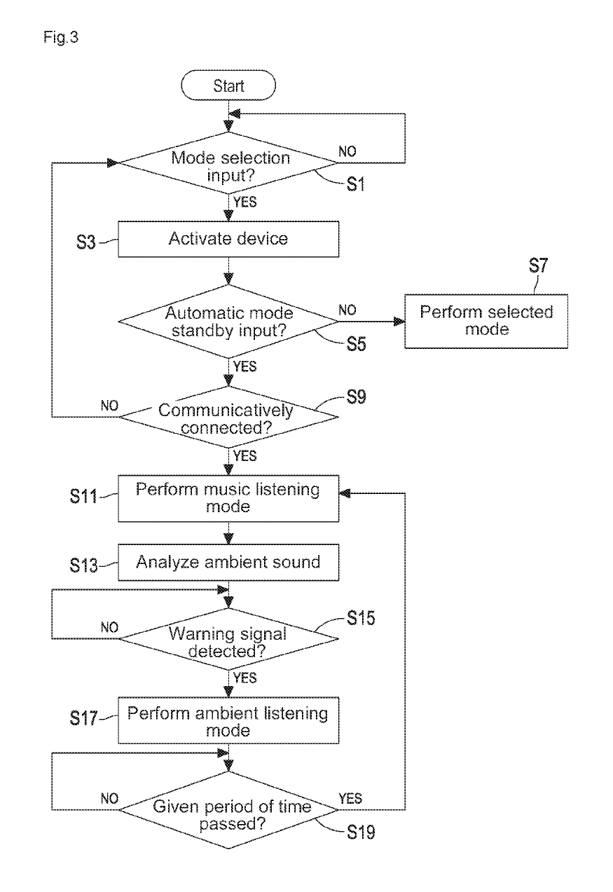

FIG. 3 is a flowchart of the operation of the audio device with the music listening function and the ambient listening function shown in FIG. 1.

The audio device may maintain the initial state before it starts working or may remain powered off before a power-on input from the input part 3.

In step S1, if the input part 3 receives a mode selection input, then it proceeds to step S3; otherwise, it stays in step S1.

In step S3, the audio device is activated, and electric power is supplied from the power supply part 1 to all the components that require power supply. For example, the communication part 11 may perform a wired or wireless communication connection with an external electronic communication device by a preset method, either on its own or under control of the controller 20, and the indication part 7 may indicate the initial state or the reception of a mode selection input. Moreover, the controller 20 is activated by electric power.

In step S5, the controller 20 checks whether or not an input from the input part 3 is an automatic mode standby input. If the input from the input part 3 is an automatic mode standby input, then the controller 20 proceeds to step S9; otherwise, that is, the input from the input part 3 is an ambient listening mode selection input or music listening mode selection input, so the controller 20 proceeds to step ST

In step S7, the controller 20 performs the selected mode, that is, the ambient listening mode or the music listening mode.

In step S9, the controller 20 checks whether the communication part 11 is communicatively connected to an electronic communication device, either on its own or under control of the controller 11 over the communication part 11. Moreover, in step S9, the controller 20 checks whether the communication part 11 is connected to an electronic communication device by a wired communication cable. Further, when Bluetooth communication is used, the controller 20 may perform a process of checking whether the communication part 11 and an electronic communication device are paired. The controller 20 performs step S9 for a certain period of time, and if the communication part 11 is communicatively connected to an electronic communication device, then the controller 20 proceeds to step S11; otherwise, it proceeds to step S1 and discards the automatic mode standby input received in the previous step S1.

In step S11, the controller 20 performs the automatic mode, and receives an audio file from the electronic communication device communicatively connected to the communication part 11 and automatically performs the music listening mode in which the audio file is played through the speaker 9.

In step S13, the controller 20 picks up and analyzes ambient sound from the first and second microphones 5a and 5b while performing the music listening mode of step S11.

In step S15, the controller 20 determines whether a warning signal is detected from the ambient sound picked up by the first and second microphones 5a and 5b. Here, the warning signal refers to a signal that changes abruptly in amplitude, like an impulse signal. If the controller 20 detects a warning signal from the ambient sound, then it proceeds to step S17; otherwise, it returns to step S13 to analyzes the ambient sound while performing the music listening mode of step S11.

In step S17, the controller 20 stops the music listening mode of step S11 and performs the ambient listening mode. That is, the controller 20 picks up ambient sound from the first and second microphones 5a and 5b and transmits it as audio to the wearer through the speaker 9, so that the wearer can directly hear the ambient sound if it contains a warning signal. In this way, the wearer is able to perceive a critical situation.

In step S19, the controller 20 checks whether the ambient listening mode of step S17 has been performed for more than a given period of time. That is, the controller 20 performs the ambient listening mode within a given period of time and performs step S19 to return to the music listening mode of step S11 after the given period of time has passed. When the given period of time has passed, the controller 20 returns to step S11; otherwise, it performs the ambient listening mode for the given period of time.

While this invention has been described in connection with what is presently considered to be practical exemplary embodiments, it is to be understood by those skilled in the art that the invention is not limited to the disclosed embodiments, but on the contrary, is intended to cover various modifications and equivalent arrangements included within the spirit and scope of the appended claims.

What is claimed is:

1. An audio device with a music listening function and an ambient listening function, the audio device comprising:
a communication part configured to perform communication with an external electronic communication device;
a microphone part configured to pick up ambient sound;
a speaker part configured to emit music or ambient sound; and
a controller configured to perform the ambient listening function to pick up ambient sound from the microphone part and emit the ambient sound to the speaker part, and perform the music listening function to play an audio file from the communication part or a stored audio file and emit the audio file through the speaker part.

2. The audio device of claim 1, wherein the controller is configured to pick up and analyze the ambient sound by controlling the microphone part while performing the music listening function.

3. The audio device of claim 2, wherein, the controller is configured to determine whether the analyzed ambient sound contains a warning signal through the analysis of the ambient sound.

4. The audio device of claim 3, wherein, the controller is configured to stop the music listening function and perform the ambient listening function if the analyzed ambient sound contains a warning signal.

5. The audio device of claim 4, wherein the controller is configured to perform the ambient listening function for a given period of time and then resume the music listening function.

6. The audio device of claim 1, further comprising an input part configured to receive at least one of a music listening function selection input, an ambient listening function selection input, and an automatic mode standby input, and wherein the input part is configured to send the at least one of the music listening function selection input, the ambient listening function selection input and the automatic mode standby input to the controller.

7. The audio device of claim 6, wherein the controller is configured to determine whether the communication part is communicatively connected to an electronic communication device upon receiving an automatic mode standby input.

8. The audio device of claim 7, wherein the controller is configured to receive an audio file from the electronic communication device to which the communication part is communicatively connected and automatically perform the music listening function.

9. A method of operating an audio device with a music listening function and an ambient listening function, the method comprising:
communicating with an external electronic communication device via a communication part of the audio device;
picking up ambient sound via a microphone part of the audio device;
emitting music or ambient sound via a speaker part of the audio device;
performing the ambient listening function to pick up ambient sound from the microphone part and emitting the ambient sound to the speaker part; and
performing the music listening function to play an audio file from the communication part or a stored audio file and emitting the audio file through the speaker part.

10. The method of claim 9, further comprising:
picking up and analyzing the ambient sound by controlling the microphone part while performing the music listening function.

11. The method of claim 10, further comprising:
determining whether the analyzed ambient sound contains a warning signal, through the analysis of the ambient sound.

12. The method of claim 11, further comprising:
stopping the music listening function and performing the ambient listening function if the analyzed ambient sound contains a warning signal.

13. The method of claim 12, further comprising:
performing the ambient listening function for a given period of time and then resuming the music listening function.

14. The method of claim 9, further comprising:
receiving at least one of a music listening function selection input, an ambient listening function selection input, and an automatic mode standby input via an input part of the audio device; and
sending the at least one of the music listening function selection input, the ambient listening function selection input and the automatic mode standby input from the input part to a controller of the audio device.

15. The method of claim 14, further comprising:
determining whether the communication part is communicatively connected to an electronic communication device upon receiving an automatic mode standby input.

16. The method of claim 15, further comprising:
receiving an audio file from the electronic communication device to which the communication part is communicatively connected and automatically performing the music listening function.
